(19) United States
(12) Patent Application Publication
(10) Pub. No.: US 2009/0030714 A1
(43) Pub. Date: Jan. 29, 2009

(54) System for printing a multiple leaf object and/or a display unit for a multiple leaf object

(76) Inventor: Ricardo Pulido Garzon, London (GB)

Correspondence Address: DEFILLO & ASSOCIATES, INC., P.O. Box 14104, Clearwater, FL, 33766, US

(21) Appl. No.: 11/985,421

(22) Filed: Nov. 15, 2007

(30) Foreign Application Priority Data
Jul. 25, 2007 (GB) 0714528.7

(51) Int. Cl. G06Q 99/00; G09F 19/00

(52) U.S. Cl. 705/1; 40/533

(57) ABSTRACT

A system for printing a multiple leaf object for a client comprises: a first picture storage medium containing a client's pictures; a second picture storage medium containing advertisements; means allowing a client to select which of said client's pictures are required for printing; means for opting for one of a first collation option of client selected pictures at a first price and a second collation option of client selected pictures and advertisements at a second price; and means for printing a multiple leaf object according to one of said collation options.

### FIELD OF THE INVENTION

The invention relates to systems for printing a multiple leaf object for a client. The invention also relates to a display unit and in particular to display units for displaying a multiple leaf object, typically a book or magazine.

### REVIEW OF ART KNOWN TO THE APPLICANT

The closest prior art known with regards to the system for printing a multiple leaf object are systems which are available online for facilitating the printing of hardback books such as encountered at the following websites: www.mypublisher.com; www.fotobook.co.uk; and www.picaboo.com.

These websites usually allow a user to download software or access online software for the collation of pictures. Once a client has sent in the pictures he/she has selected and/or edited with additional text or otherwise from their own collection of pictures, the printer then prints a photo album in the form of a hardback book the downloadable or accessable software allows the client to associate description with the pictures and to add graphics in order to adapt the shape of the displays. The end product is a fully customised book, which displays no advertisements other than an acknowledgement of the printer in the conventional fashion. The first and second broad independent aspects of the invention respectively define systems and/or methods to produce multiple leaf objects in an alternative manner.

With regards to the third broad independent aspect, the closest art known to the applicant is a conventional picture frame. A picture frame incorporates neither an enclosure for primarily containing, in use, a multiple leaf object nor does it provide an enclosure substantially corresponding in size to the multiple leaf objects.

A picture frame is intended to display single leaf objects, typically works of art, photographs, certificates and the like. The displayed single leaf objects are inserted into the picture via access from the rear of the unit. The displayed single leaf object(s) are permanently built into the picture frame, without the intention of being easily removable.

### SUMMARY OF THE INVENTION

In a first broad independent aspect, the invention provides a system for printing a multiple leaf object for a client or customer comprising:

a first picture storage medium containing a client's pictures;

a second picture storage medium containing advertisements; means allowing a client to select which of said client's pictures are required for printing;

means for opting for one of a first collation option of client selected pictures at a first price and a second collation option of client selected pictures and advertisements at a second price; and

means for printing a multiple leaf object according to one of said collation options.

This allows the customer to select from a plurality of different options which will result, in at least some of the options, in a product which was hitherto not obtained despite the numerous attempts in the prior art.

In a subsidiary aspect, said means for printing prints a multiple leaf object with a soft cover. This goes against conventional thinking in this field, which insists on providing hardback books. The combination of a soft cover and the display unit, which is broadly defined below allows the structural strength of a book to be obtained with the added practicality of a magazine.

In a further subsidiary aspect, the system further comprises means for opting for the system's brand name to be printed on the front cover of the multiple leaf object. Contrary to the prior art, this allows the system operator to place a brand name across the front page instead of having to display the brand at a location which would be essentially hidden or would go unnoticed.

In a further subsidiary aspect, the system further comprises means for selecting the proportion of advertisements relative to the client's selected pictures and adapting the price of printing said multiple leaf objects in accordance with said selection. This allows a wider variety of price options to be presented to a client.

In a second broad independent aspect, the invention provides a method for printing a multiple leaf object for a client or customer comprising the steps of:

receiving a selection of client pictures;

offering to a client one of a first collation option of client selected pictures at a first price and a second collation option of client selected pictures and advertisements at a second price; and

printing a multiple leaf object according to one of said collation options.

In a subsidiary aspect, the method further comprises the step of printing a multiple leaf objection with a soft cover.

In a further subsidiary aspect, the method further comprises the step of offering to a client the option of printing the system's brand name on the front cover of the multiple leaf object.

In a further subsidiary aspect, the method further comprises the step of offering to a client to select the proportion of advertisements relative to the client's selected pictures and adapting the price of printing said multiple leaf object in accordance with said selection.

In a third broad independent aspect, the invention provides a wall-mountable display unit comprising a front panel, a rear panel, and side panels located between the front panel and the rear panel, the front panel being transparent enough to enable the viewing, in use, of a multiple leaf object such as a book, magazine or the like when located in said display unit; characterised in that the panels form: a) an enclosure for primarily containing, in use, a multiple leaf object; and b) an enclosure substantially corresponding in size to the multiple leaf object.

This configuration is particularly advantageous because the unit encloses and displays a multiple leaf display object, whilst the unit is mounted on a wall. Another advantage of this configuration is that the enclosure may support and maintain the displayed multiple leaf object in a flat and vertical display position. Another advantage of this configuration is that the unit's size may be kept to a minimum, which reduces its weight and required footprint for mounting on a wall.

In a subsidiary aspect in accordance with the invention's third broad independent aspect, said display unit incorporates one or more hinges located between said front panel and said rear panel; whereby said display unit is openable as a book.

This configuration is particularly advantageous because it enables easy access to the enclosed displayed multiple leaf object, without necessarily dismantling the unit. Another advantage of this configuration is that it may enable access to the whole displayed multiple leaf object, whilst being supported by the unit.

In a further subsidiary aspect in accordance with the invention's third broad independent aspect, upper and lower side panels extend from said rear panel and engage, in use, the upper and lower edges of a multiple leaf object to secure said object in position; a lateral opening facilitates the insertion and removal of the multiple leaf object; upper and lower side panels extend from said front panel and overlap said upper and lower side panels of said rear panel; and a lateral panel extends from said front panel to cover said lateral opening when said front panel and said rear panel are closed to form said enclosure.

Optionally, it may accommodate the displayed multiple leaf object in a close fit between the upper and lower side panels, which extend from the rear panel. The close fit may support and constrain the displayed multiple leaf object without the requirement for additional attachment means, mounting means and external decorative features. Another optional configuration where the front and rear panels are close together is that they form an enclosure about the displayed multiple leaf object, whilst simultaneously supporting it vertically. In another subsidiary aspect, the insertion and/or removal of the displayed multiple leaf object is not obstructed by any of the enclosure members.

In a further subsidiary aspect, said rear panel incorporates side panels, which are L-shaped in cross-section to secure the upper and lower edges of said object.

This configuration is particularly advantageous because it enables the lateral movement required to insert or remove the displayed multiple leaf object, whilst being supported and constrained vertically.

In a further subsidiary aspect, said side panels incorporate one or more transparent portions to enable the viewing of said object when located in said unit.

This marks a complete departure from known display units such as picture frames which typically obscure the edges of the object held in the frame by necessarily choosing frames of woods or metal to disguise the edge of the object.

In a further subsidiary aspect, said front panel and/or rear panel incorporate one or more borders to conceal said object's peripheral edges.

This configuration is particularly advantageous because it gives the impression that the displayed multiple leaf object, is in conventional framed unit, without utilising known picture framing techniques. Another advantage of this configuration is that it eliminates the requirement for incorporating any covering members dedicated to covering the peripheral edge of displayed multiple leaf object, whilst incorporated within the unit.

In a further subsidiary aspect, said unit incorporates means for securing said display unit to a wall.

This configuration is particularly advantageous because it enables the unit to be mounted on a wall following a similar method as a conventional picture frame. Optionally, the display unit is constructed to enable the displayed multiple leaf object to be inserted or removed from the unit, whilst the unit is mounted on a wall.

In a further subsidiary aspect, said securing means incorporate an oblong cavity, which extends laterally. This is particularly advantageous because it allows the hooking position to be varied in order to allow the display unit to be mounted straight both horizontally and vertically. This is particularly beneficial when the multiple leaf object has a relatively heavier binding side in which case the hooking position would be chosen closer to the binding in order to achieve a balanced display unit.

Optionally, it is sized to provide a close and supportive mount for displaying a multiple leaf object, such as a book or magazine.

In a further subsidiary aspect in accordance with the invention's third broad independent aspect, one or more side panels extend from said front panel so that the combination of said side panels and said front panel forms a front portion; and one or more panels extend from said rear panel so that the combination of said side panels and said rear panel forms a rear portion; and wherein said rear portion fits into said front portion; said rear portion and said front portion are separable from one another; and releasable attachment means are provided to secure said front portion to said rear portion.

This configuration is particularly advantageous because it enables the displayed multiple leaf object to be enclosed between overlapping portions of the unit. This allows the front portion to be separable from the rear portion for maintenance or repair. This also enables front or rear portions to be replaced when they are beyond economical repair. This enables the front portion to be interchangeable with an alternative front portion, which incorporates an alternative style of border. Another advantage of this configuration is that the rear portion is interchangeable with an alternative rear portion, which incorporates an alternative mount for the displayed multiple leaf object.

### BRIEF DESCRIPTION OF THE FIGURES

FIG. 1 shows front view of the display unit.

FIG. 2 shows a rear view of the display unit.

FIG. 3a shows a perspective vertical view of the display unit's left side.

FIG. 3b shows a perspective horizontal view of the display unit's right side.

FIG. 4 shows a side view of the display unit mounted on a wall.

FIG. 5 shows a side view of a partially opened display unit.

FIG. 6 shows a front perspective view of display unit.

FIG. 7 shows a fully opened display unit, which illustrates the installing/removal of a displayed item.

FIG. 8 shows a cross sectional side view of an alternative embodiment of the invention.

FIG. 9 shows a perspective view of a further embodiment of the invention.

FIG. 10 shows a perspective view of a second part of the embodiment of FIG. 9.

FIG. 11 shows a perspective view of a third part of the embodiment of FIG. 9.

FIG. 12 shows a perspective view of a fourth part of the embodiment of FIG. 9.

FIG. 13 shows a perspective view of the assembled display unit of the embodiment of FIG. 9 from the front.

FIG. 14 shows a perspective view from the back of the display unit of the embodiment of FIG. 9.

FIG. 15 shows a flow diagram of the process of compiling a magazine with advertisements.

### DETAILED DESCRIPTION OF THE FIGURES

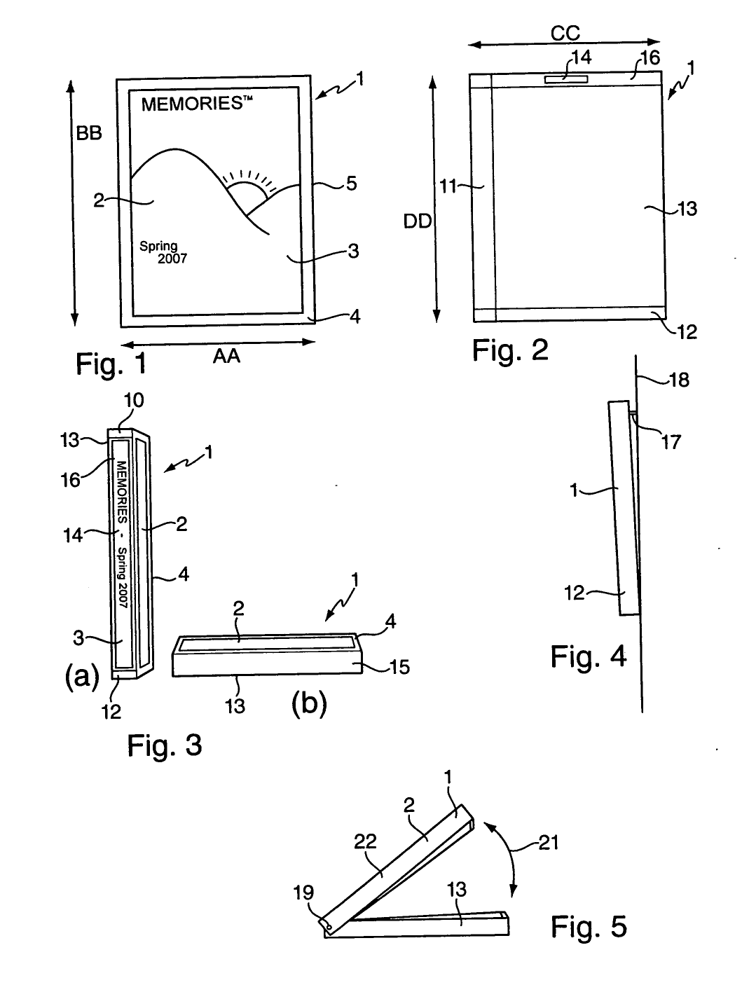

FIG. 1 shows a rectangular display unit 1, which incorporates a transparent front member 2, which extends along the unit's front vertical plane along axes AA and BB. Transparent member 2 is typically constructed from a glass or plastic sheet, which covers and supports the display item 3 within the display unit 1. The display item 3 is a multi-leaf device, typically a book or magazine. The display unit 1 incorporates a boarder 4 within the transparent member's peripheral edge 5.

FIG. 2 shows the rear view of the display unit 1 (as illustrated in FIG. 1) which incorporates a rectangular rear portion 13. The rectangular rear portion 13 vertically extends along axes CC and DD. Rectangular rear portion is substantially more vertical along axis DD. The display device incorporates a rectangular member 10, which is attached to the uppermost portion of rectangular rear portion 13 and extends horizontally along axis CC. The display device incorporates a rectangular member 12, which is attached to the lowermost portion of the rectangular rear portion 13 and extends horizontally along axis CC. The display device incorporates a rectangular member 11, which is attached to the leftmost portion of rectangular rear portion 13 and extends vertically along axis DD. A rectangular wall mount 14 is located centrally in rectangular member 10 and extends horizontally along axis CC.

FIG. 3a shows the display unit 1 (as illustrated in FIG. 1) standing vertically upright and being supported by lower rectangular member 12. The display unit's transparent front member 2 is shown to be closed onto rectangular rear portion 13, upper rectangular supporting member 10 and lower rectangular supporting member 12. The transparent front member 2 is closed about the multi-leaf display object 3, which can be seen through a transparent side portion 14 that is located within the unit's left, side wall 16. The transparent side portion 14 is located between upper rectangular supporting member 10, lower rectangular supporting member 12 and perpendicularly from rectangular rear portion 13. The display unit 1 incorporates a boarder 4 within the display unit's transparent front member 2.

FIG. 3b shows the display unit 1 (as illustrated in FIG. 1) laying horizontally on its rear surface 13. The display unit 1 incorporates a non-transparent, right side wall outer surface 15, which is perpendicular to rectangular rear portion 13. The display unit 1 incorporates a boarder 4 within the display unit's transparent front member 2.

FIG. 4 shows a side view of the display unit 1 (as illustrated in FIG. 1) which is attached to an interior wall 18 via an attachment member 17 that is perpendicular to the wall 16. The display unit 1 is shown to be inclining vertically downwards, where its bottom rectangular member 12 is in contact with the interior wall 18.

FIG. 5 shows a semi-open display unit 1 (as illustrated in FIG. 1), which indicates the directions for opening and shutting unit 1 with a bi-directional arrow 21. The front wall member 2 and rear wall member 13 are attached together via two hinges 19 (only the lower hinge is shown). The lower hinge 19 is located on the left most portion of the front wall member's lower, outer wall surface 22.

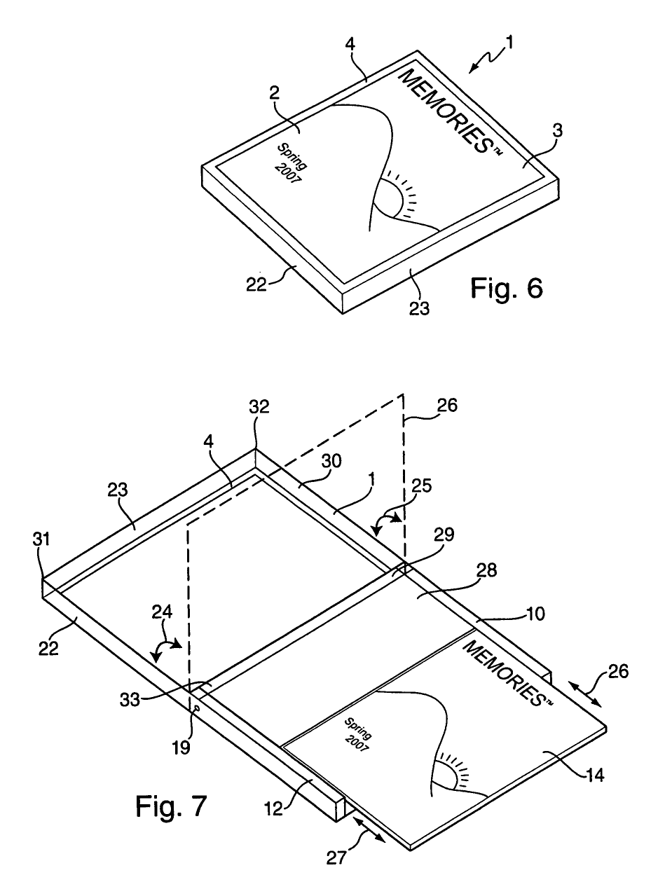

FIG. 6 shows a front perspective view of the display unit 1 (as illustrated in FIG. 1) which incorporates a multi-leaf display item 3. The transparent front member 2 is enclosed about the multi-leaf display item 3 and incorporates a border 4 about its front facing, peripheral edge. The transparent front member 2 incorporates a lower containing wall 22 and an outer side containing wall 23. Both containing walls 22 and 23 are perpendicular to the transparent front member 2.

FIG. 7 shows the display unit 1 (as illustrated in FIG. 1), fully opened like a book. The side rectangular portions 22, 23 and 30 are all perpendicular to the transparent front member 2. Side rectangular portions 22 and 23 are shown abutted together at section 31.

Side rectangular portions 23 and 30 are shown abutted together at section 32. The opening and closing movement of the display unit 1 are indicated by arrows 24 and 25.

The movement of the front wall member 2 onto the rear wall member 13 is shown by a broken rectangular line, which represents the front wall member 2 in its half closed state 26. The multi-leaf display unit 14 is inserted or removed into a display recess 28, in the direction indicated by arrows 26 and 27. The display recess 28 exists between rectangular side members 10 and 12. The attachment of the front wall member to the rear wall member is shown via hinges 19 (only the lower hinge is shown). The front wall member incorporates a boarder 4 along its side rectangular portions 22, 23 and 30 front facing, peripheral edge. A rectangular side member 29 is abutting the leftmost portion of display recess 28, between rectangular supporting members 10 and 12. Rectangular side member 29 incorporates a vertical border 33 along its front facing edge 29.

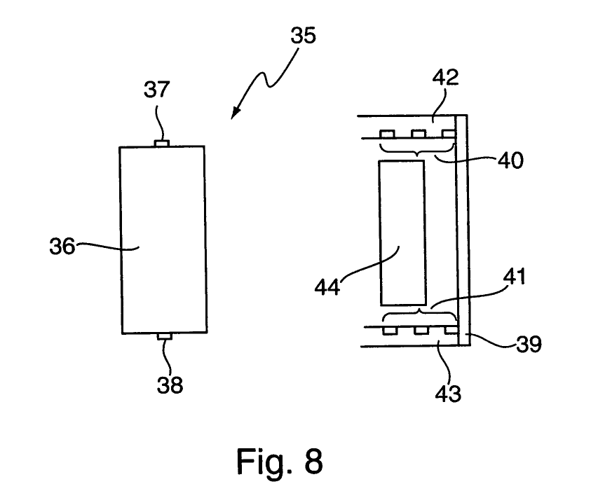

FIG. 8 shows an alternative embodiment of the display unit 35, which incorporates a rear wall member 36 that incorporates an upper “snap-fit” latch 37 and a lower “snap-fit” latch 38. The alternative rear wall member 36 locates into an alternative front wall member 39, which incorporates an array of cavities 40, within the upper supporting member 42, for accommodating the rear panel's upper latch 37. The alternative front wall member 39 incorporates an array of cavities 41, within the lower supporting member 43, for accommodating the rear panel's lower latch 41. The multi-leaf display objects 44 is then located between the alternative front wall member 39 and alternative rear wall member 36 and the latching of the upper and lower “snap-fit” latches 37 and 38 within the upper and lower cavity arrays 40 and 41 enables width adjustment for enclosing the multi-leaf display object 44. Alternate means may be provided to vary the size of the multiple leaf object enclosure. These may be selected from the group comprising: filamentary touch to close pads located on a first portion and a second portion, a threaded member for securing one portion to the other for various enclosure sizes, one or both of the enclosure forming members may be elastic to allow multiple leaf objects of various sizes to be secured in the display unit.

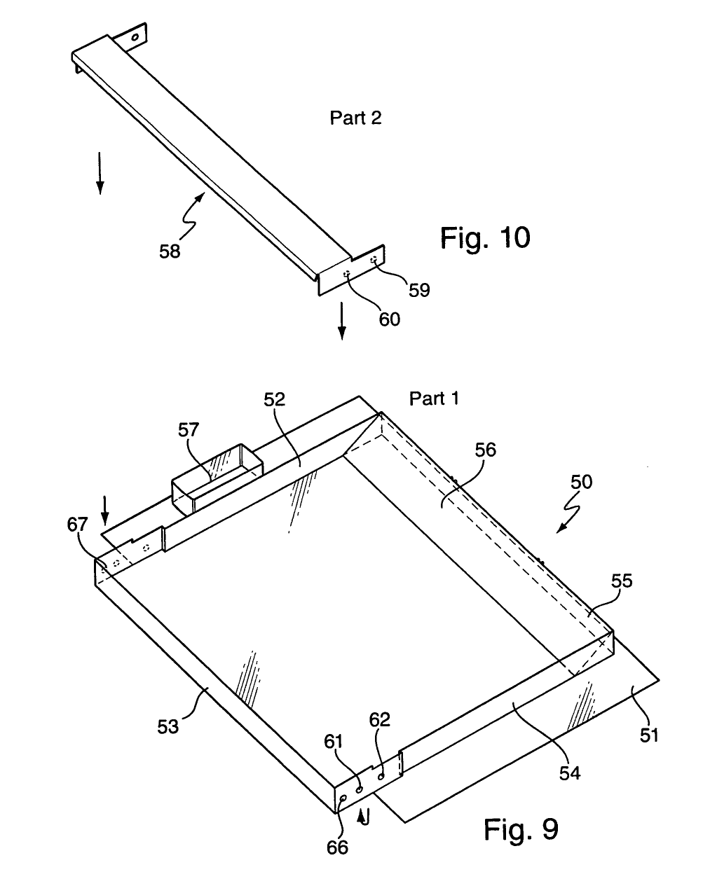

FIG. 9 shows the rear portion, generally referenced 50 of a display unit. Back portion 50 incorporates a back panel 51 with side panels 52, 53, 54 and 55. A ramp 56 allows the magazine once placed in the cavity formed by the sidewalls and the back panel to be more readily immobilised. A rectangular aperture 57 allows the display unit to be mounted on a wall, as it is of sufficient size to accommodate a wall mounted nail or the like.

FIG. 10 shows a member 58, which is suitable for releasable attachment to side portions 52 and 54. Projections such as projection 59 and 60 locate inside apertures 61 and 62. Alternative constructions may be envisaged where for example portions 61 and 62 are projections which fit into portion 60 and 59 provided these are recesses.

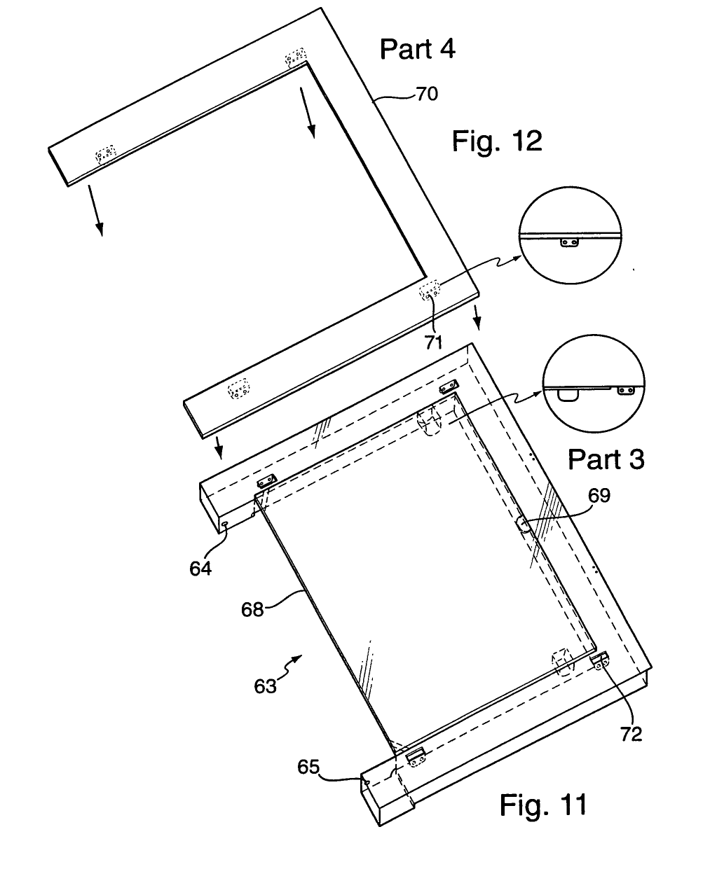

FIG. 11 shows the top portion of the display unit generally referenced 63. The top portion is formed of an integral portion of moulded plastics. It allows the display unit to open like a book because it incorporates hinges with projections 64 and 65, which clip into recesses or apertures 66 and 67 in the back portion 50 of the display unit. Under the front panel 68 which is preferably of transparent material, there are provided a number of inwardly projecting thumbs such as thumb 69 which allow a photograph of the magazine cover for example to be secured tightly against the front panel 68. Frame 70 (as shown in FIG. 12) is also envisaged and may be clipped into the front portion 63. In order to achieve this, a number of projections such as projection 71 are envisaged and sized and configured to fit within recesses such as recess 72 located in the front portion 63.

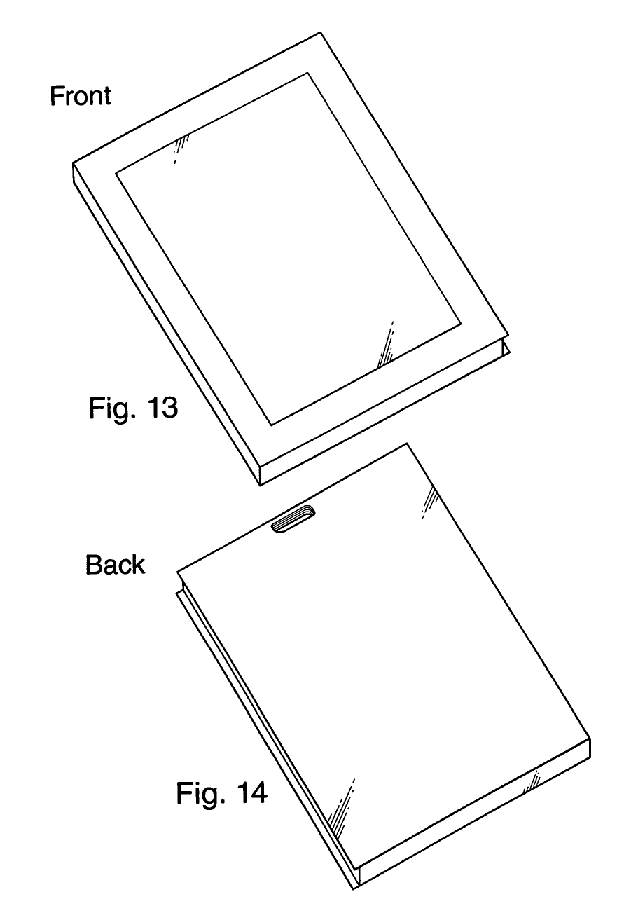

After clipping in parts 1 to 4, the display unit takes the form of a shallow walled enclosure for primarily displaying and containing a multiple leaf object such as a magazine. FIG. 13 shows the front view of the assembled parts described individually in FIGS. 9 to 12. FIG. 14 shows the rear view of the assembled display unit.

Other decorative elements may be placed on top of the front portion of the display unit such as a frame incorporating a bear, a heart or any other releasably attachable frame elements selected from a range of available colours.

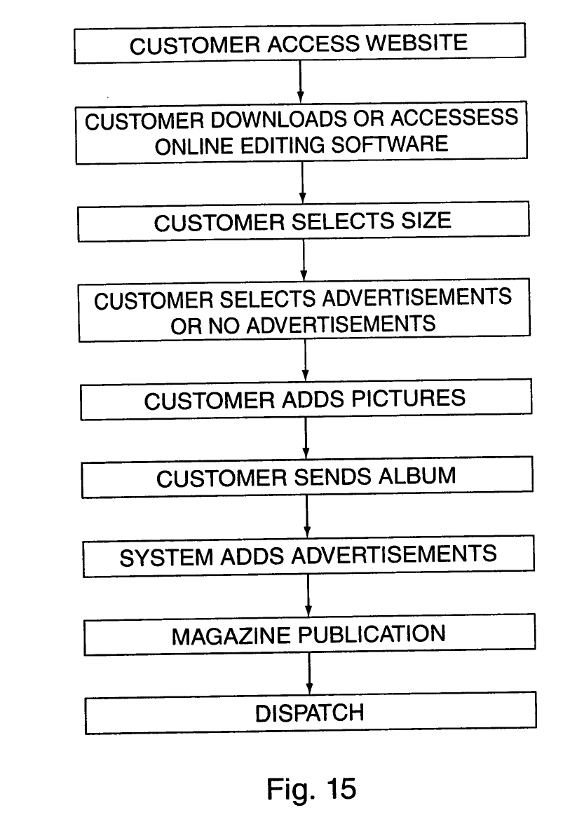

FIG. 15 shows the process associated with the system for printing and/or editing and/or publishing multiple leaf objects. Editing software for producing photo books is well known. An example of such software may be downloaded from a printer's website such as www.mypublisher.com. The system operates in a similar fashion to the prior art in that it is web-based either in an accessable form run remotely or in a downloadable form run locally. A customer accesses the website and downloads the necessary editing software which is then operated from the customer's terminal. From the data storage region of a customer's hard disc, memory card or other appropriate storage medium, the customer accesses one or more of his/her pictures and subsequently selects and edits them into a virtual, and/or electronic book or magazine. The software allows the user to select the size of the book or magazine from two or more predetermined sizes.

The software will also subsequently offer the option to a customer of selecting the incorporation or not of advertisements throughout the magazine or photo book. The advertisement options selected by the customer are adapted to have consequences on the cost. For example, if a customer selects the “without advertisements” option the maximum or full price will be charged. If the customer selects a further option where, for example, one advertisement appears every five pages, the system will indicate that a 15% discount off the full price is available if the customer selects this option. A further option may be provided where two advertisements every five pages are proposed with an additional discount which provides an overall total discount of 20% off the full price.

The system may also allow the customer to select the location and category of advertisements. For example, the system may present the options of travel, fashion, sports or luxury items

to be advertised. Again, the price may be tailored dependant upon the options selected.

The advertisements may also be selected by the system dependent upon the profile of the customer. For example, a group of advertisements may be selected for a particular gender, age group or dependent upon the content of the virtual or unprinted photo book.

Once the customer has selected the advertising option and edited the photo/magazine book it is sent in signal form over the internet to the operator's database where a storage medium with advertisement material is stored and added by the system operator.

In addition, the software may offer the option of a front cover advertisement. In one preferred embodiment, the operator's own brand would appear in a similar fashion to the title on a magazine at the top of a cover sheet. A number of different titles may be selected by the system. The operator of the system organises the publishing of the magazine and places the magazine in a display unit of the kind described above for dispatch by mail to the customer. For the process of publishing magazines, publishing means are employed which may be a printer.

Whilst the system of FIG. 15 envisages a dispatch step, the dispatch step may optionally provide a plurality of fields which may be filled in by a user of the system to indicate a plurality of destinations for the printed material.

The system may be accessable by individuals or companies. Companies may for example submit a portfolio for their own customers with the customers pictures and the company's own advertisement material so that the operator simply adapts the file for printing. This would be particularly advantageous because it would allow local companies to select local adverts which may be of greater relevance than the adverts selected by the operator.

The system may be adapted to incorporate personal photographs in association with adverts on the same page. Alternatively, a personal picture may be incorporated to copyright material such as into a cartoon so that an individual takes part in the story alongside cartoon characters. In addition, it is envisaged that commercial advertisements may be inserted into pages of cartoon material. A discount may be offered when an individual accepts the incorporation of advertisements between personal pictures and or a combination of personal pictures and cartoon based copyright material.

1. A system for printing a multiple leaf object for a client comprising:
a first picture storage medium containing a client's pictures;
a second picture storage medium containing advertisements;
means allowing a client to select which of said client's pictures are required for printing;
means for opting for one of a first collation option of client selected pictures at a first price and a second collation option of client selected pictures and advertisements at a second price; and
means for printing a multiple leaf object according to one of said collation options.

2. The system according to claim 1, wherein said means for printing prints a multiple leaf object with a soft cover.

3. The system according to claim 1, further comprising means for opting for the system's brand name to be printed on the front cover of the printed multiple leaf object.

4. The system according to claim 1, further comprising means for selecting the proportion of advertisements relative to the client selected pictures and adapting the price of printing said multiple leaf object in accordance with said selection.

5. A method for printing a multiple leaf object for a client comprising the steps of:
receiving a selection of client pictures;
offering to a client one of a first collation option of client selected pictures at a first price and a second collation option of client selected pictures and advertisements at a second price; and
printing a multiple leaf object according to one of said collation options.

6. The A method according to claim 5, further comprising the step of printing a multiple leaf object with a soft cover.

7. The method according to claim 5, further comprising the step of offering to a client the option of printing the system's brand name on the front cover of the multiple leaf object.

8. The method according to claim 5, further comprising the step of offering to a client to select the proportion of advertisements relative to the client selected pictures and adapting the price of printing said multiple leaf object in accordance with said selection.

9. A wall-mountable display unit comprising:
a front panel,
a rear panel, and
side panels located between the front panel and the rear panel, the front panel being transparent enough to enable the viewing, in use, of a multiple leaf object when located in said display unit;
wherein the panels form:
a) an enclosure for primarily containing, in use, a multiple leaf object; and
b) an enclosure substantially corresponding in size to the multiple leaf object.

10. The display unit according to claim 9, wherein said display unit incorporates at least one hinge located between said front panel and said rear panel; whereby said display unit is openable as a book.

11. The display unit according to claim 9, wherein upper and lower side panels extend from said rear panel and engage, in use, the upper and lower edges of a multiple leaf object to secure said object in position; a lateral opening facilitates the insertion and removal of the multiple leaf object; upper and lower side panels extend from said front panel and overlap said upper and lower side panels of said rear panel; and a lateral panel extends from said front panel to cover said lateral opening when said front panel and said rear panel are closed to form said enclosure.

12. The display unit according to claim 9, wherein said rear panel incorporates side panels, which are L-shaped in cross-section to secure the upper and lower edges of said object.

13. The display unit according to claim 9, wherein said side panels incorporates at least one transparent portion to enable the viewing of said object when located in said unit.

14. The display unit according to claim 9, wherein one of said front panel and said rear panel incorporate at least one border to conceal said object's peripheral edges.

15. The display unit according to claim 9, wherein said unit incorporates means for securing said display unit to a wall.

16. The display unit according to claim 15, wherein said securing means incorporate an oblong aperture in said rear panel, which extends laterally.

17. The display unit according to claim 9, wherein at least one side panel extends from said front panel so that the combination of said side panel and said front panel forms a front portion; and at least one side panel extends from said rear panel so that the combination of said side panel and said rear panel forms a rear portion; and wherein said rear portion fits into said front portion; said rear portion and said front portion are separable from one another; and releasable attachment means are provided to secure said front portion to said rear portion.
